(19) United States
(12) Patent Application Publication
(10) Pub. No.: US 2019/0158332 A1
(43) Pub. Date: May 23, 2019

(54) RESOURCE BLOCK INDEXING

(71) Applicant: QUALCOMM Incorporated, San Diego, CA (US)

(72) Inventors: Sony AKKARAKARAN, Poway, CA (US); Amir AMINZADEH GOHARI, Sunnyvale, CA (US); Renqiu WANG, San Diego, CA (US); Tao LUO, San Diego, CA (US); Yi HUANG, San Diego, CA (US)

(21) Appl. No.: 16/192,426

(22) Filed: Nov. 15, 2018

Related U.S. Application Data
(60) Provisional application No. 62/587,993, filed on Nov. 17, 2017.

(51) Int. Cl. H04L 27/26; H04L 5/00; H04W 16/14; H04W 72/12; H04B 17/382

(52) U.S. Cl. CPC H04L 27/2636; H04L 5/0096; H04B 17/382; H04W 72/1294; H04W 16/14

(57) ABSTRACT

The present methods and apparatus relate to wireless communications at either a user equipment (UE) or a network entity in a new radio communication system. The described aspects include receiving, via a communication channel, a scheduling grant from a transmitting wireless device, the scheduling grant including a Resource Indication Value (RIV) corresponding to an allocation of resource blocks (RBs) for communicating on the communication channel. The described aspects further include mapping the RIV to a constrained set of one or more RBs to identify allocated RBs, the constrained set of one or more RBs including a fewer number of RBs than a number of available RBs in a slot or transmission duration. The described aspects further include communicating, with the transmitting wireless device via the communication channel, using the allocated RBs from the constrained set of one or more RBs as signaled by the RIV.

### CLAIM OF PRIORITY

The present Application for Patent claims priority to U.S. Application No. 62/587,993 entitled “RESOURCE BLOCK INDEXING” filed Nov. 17, 2017, which is assigned to the assignee hereof and hereby expressly incorporated by reference herein.

### BACKGROUND

### Technical Field

The present disclosure relates generally to communication systems, and more particularly, to a techniques for resource block indexing in a new radio shared spectrum wireless communication network.

### Introduction

Wireless communication networks are widely deployed to provide various telecommunication services such as telephony, video, data, messaging, and broadcasts. Typical wireless communication networks may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

As the number of packets being transmitted increases with 5G NR, techniques are needed to provide efficient and improved processes during wireless communications. In certain instances, as the next generation of wireless communications come into existence, current fixed or relatively inflexible transmission scehduling may become a hindrance to achieving adequate or improved levels of wireless communications. Thus, improvements in wireless communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method includes wireless communications at either a user equipment (UE) or a network entity in a new radio communication system. The described aspects include receiving, via a communication channel, a scheduling grant from a transmitting wireless device, the scheduling grant including a Resource Indication Value (RIV) corresponding to an allocation of resource blocks (RBs) for communicating on the communication channel. The described aspects further include mapping the RIV to a constrained set of one or more RBs to identify allocated RBs, the constrained set of one or more RBs including a fewer number of RBs than a number of available RBs in a slot or transmission duration. The described aspects further include communicating, with the transmitting wireless device via the communication channel, using the allocated RBs from the constrained set of one or more RBs as signaled by the RIV.

In an aspect, an apparatus for wireless communications at either a UE or a network entity in a new radio communication system may include a transceiver, a memory; and at least one processor coupled with the memory and configured to receive, via a communication channel, a scheduling grant from a transmitting wireless device, the scheduling grant including a RIV corresponding to an allocation of RBs for communicating on the communication channel. The at least one processor is further configured to map the RIV to a constrained set of one or more RBs to identify allocated RBs, the constrained set of one or more RBs including a fewer number of RBs than a number of available RBs in a slot or transmission duration. The at least one processor is further configured to communicate, with the transmitting wireless device via the communication channel, using the allocated RBs from the constrained set of one or more RBs as signaled by the RIV.

In an aspect, a computer-readable medium may store computer executable code for wireless communications at either a UE or a network entity in a new radio communication system is described. The described aspects include code for receiving, via a communication channel, a scheduling grant from a transmitting wireless device, the scheduling grant including a RIV corresponding to an allocation of RBs for communicating on the communication channel. The described aspects further include code for mapping the RIV to a constrained set of one or more RBs to identify allocated RBs, the constrained set of one or more RBs including a fewer number of RBs than a number of available RBs in a slot or transmission duration. The described aspects further include code for communicating, with the transmitting wireless device via the communication channel, using the allocated RBs from the constrained set of one or more RBs as signaled by the RIV.

In an aspect, an apparatus for wireless communications at either a UE or a network entity in a new radio communication system is described. The described aspects include means for receiving, via a communication channel, a scheduling grant from a transmitting wireless device, the scheduling grant including a RIV corresponding to an allocation of RBs for communicating on the communication channel. The described aspects further include means for mapping the RIV to a constrained set of one or more RBs to identify allocated RBs, the constrained set of one or more RBs including a fewer number of RBs than a number of available RBs in a slot or transmission duration. The described aspects further include means for communicating, with the transmitting wireless device via the communication channel, using the allocated RBs from the constrained set of one or more RBs as signaled by the RIV

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram of an example of a wireless communication network including at least one base station and at least one UE, both of which have a RB indexing component;

FIG. 2A is a diagram illustrating an example of a DL subframe for a 5G/NR frame structure;

FIG. 2B is a diagram illustrating an example of DL channels within the DL subframe for a 5G/NR frame structure;

FIG. 2C is a diagram illustrating an example of an UL subframe for a 5G/NR frame structure;

FIG. 2D is a diagram illustrating an example of UL channels within the UL subframe for a 5G/NR frame structure;

FIG. 3 is a diagram illustrating an example of a base station and user equipment (UE) in an access network;

FIG. 4 is a conceptual diagram of an example of RB indexing in accordance with one or more aspects of the disclosure;

FIG. 5 is a flow diagram illustrating an example of a method of communications in a wireless communication system in accordance with one or more aspects of the disclosure;

FIG. 6 is a schematic diagram of example components of the UE of FIG. 1; and

FIG. 7 is a schematic diagram of example components of the base station of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to resource block indexing for new radio (NR) shared spectrum. Specifically, conventional implementations may be unsuited for facilitating communication between UEs and network entities utilizing RB indexing. In an example, for LTE systems, a Resource Indication Value (RIV) is a number to specify Physical Downlink Shared Channel (PDSCH) or Physical Uplink Shared Channel (PUSCH) resource allocation. In some instances, the RIV includes two values (e.g., a number of resource blocks (RBs) and a starting RB) for the resource allocation. For 5G NR systems, resource allocation may include a start and stop OFDM symbol within a slot of a subframe, and indicating this additional information may require more overhead. Hence, more compact encoding of RIV may be desirable to limit the increase in overhead

Accordingly, in some aspects, the present methods and apparatuses may provide an efficient solution, as compared to conventional solutions, by utilizing resource allocation schemes to reduce overhead for RB indexing in a new radio shared spectrum. In particular, in the present aspects, an RB indexing scheme may take into account constraints on allowed values of RBs that can be allocated. For instance, the constraint on allowable RBs may be due to suitable RBs available for certain waveforms or based on other resource-allocation types that may be used to make resource allocation more efficient. As such, in an implementation, a receiving wireless device (e.g., a UE or gNB) may efficiently and effectively receive, via a communication channel, a scheduling grant from a transmitting wireless device, where the scheduling grant includes a RIV corresponding to an allocation of RBs for communicating on the communication channel. Further, the receiving wireless device may map the RIV to a constrained set of one or more RBs to identify allocated RBs, where the constrained set of one or more RBs include a fewer number of RBs than a number of available RBs in a slot or transmission duration. As a result, the receiving wireless device may communicate with the transmitting wireless device, via the communication channel, using the allocated RBs from the constrained set of one or more RBs as signaled by the RIV. Thus, the apparatus and methods of RB indexing described herein may be used in uplink (UL) or downlink (DL) communications.

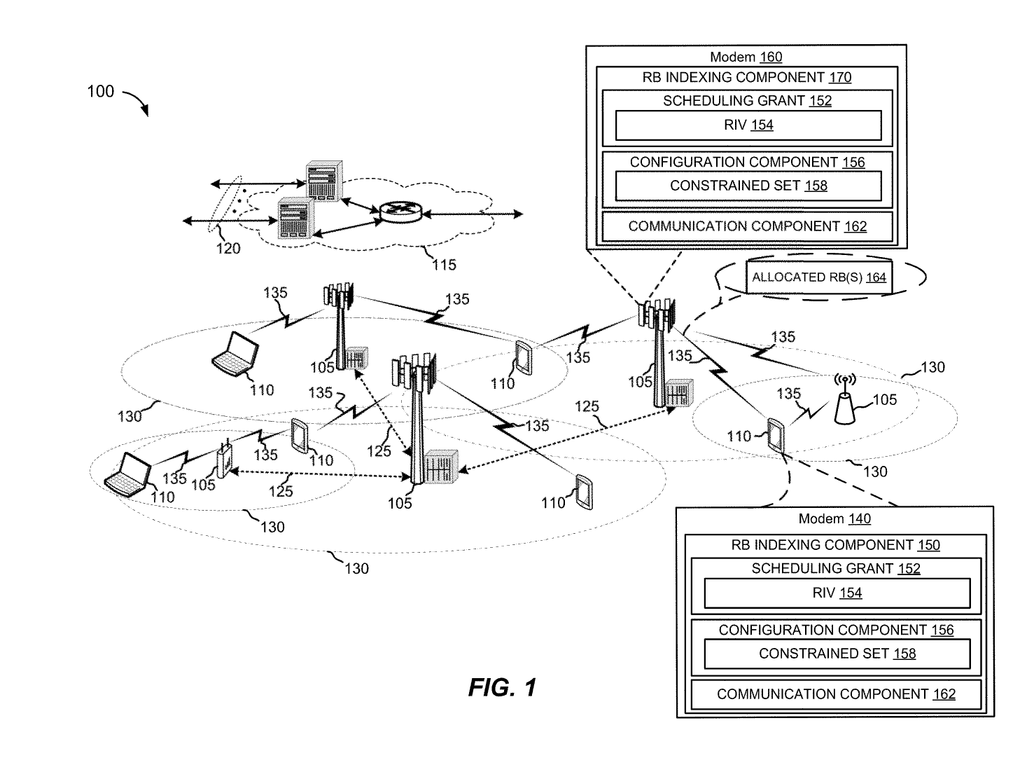

Additional features of the present aspects are described in more detail below with respect to FIGS. 1-7.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Referring to FIG. 1, in accordance with various aspects of the present disclosure, an example of a wireless communication network 100 including at least one UE 110 and at least one base station 105 each having similar resource block (RB) indexing components, either or both of which may utilize one or more RB indexing schemes that take into account constraints on allowed values of RBs that can be allocated. For example, in one implementation, the UE 110 may include a modem 140 having a RB indexing component 150 that performs resource allocation for one or more RBs in a wireless communication system. Further, the wireless communication network 100 includes at least one base station 105 with a modem 160 having a RB indexing component 170 that operates similar to RB indexing component 150 by performing resource allocation for one or more RBs in a wireless communication system. As described herein, for the purposes of simplicity, RB indexing component 170 may include the same/similar subcomponents and perform the same/similar features as RB indexing component 150.

In an aspect, in an example of operation where the UE 110 is the receiving wireless device and the base station (or gNB) 105 is the transmitting wireless device, the UE 110 and/or the RB indexing component 150 may receive, via a communication channel 135, a scheduling grant 152 from the base station 105. For example, the scheduling grant 152 may include a RIV 154 corresponding to an allocation of RBs for communicating on the communication channel 135.

In this case, the UE 110 and/or the RB indexing component 150 may include a configuration component 156, which may be configured to map the RIV 154 to a constrained set 158 of one or more RBs to identify allocated RBs 164. For example, the constrained set 158 of one or more RBs may include a fewer number of RBs than a number of available RBs in a slot or transmission duration.

Further, in some optional implementations, the UE 110 and/or the RB indexing component 150 may receive, via the communication channel 135, a scheduling scheme indicator associated with the scheduling grant 152. For example, the scheduling scheme indicator may identify a scheduling scheme related to the scheduling grant 152. The UE 110 and/or the RB indexing component 150 may determine the scheduling scheme based at least on a value of the scheduling scheme indicator. In other alternatives, the receiving wireless device, e.g., the UE 110 in this case, may already know the scheduling scheme, such as based on a preconfiguration, etc.

In any case, the configuration component 156 may map the RIV 154 to the constrained set 158 of one or more RBs based at least on the scheduling scheme.

In an aspect, the scheduling scheme may comprise a waveform-based scheme or a resource-allocation type scheme. For example, the scheduling scheme may correspond to Discrete Fourier Transform Spreading Orthogonal Frequency Division Multiplexing (DFTS-OFDM). That is, for DFTS-OFDM, the assigned number of RBs need to be of form 2ⁱ 3^{j} 5^{k} for integer values of i,j,k, in order to limit the complexity of DFT spreading.

In this DFTS-OFDM example, the configuration component 156 may map the RIV 154 to the constrained set 158 of one or more RBs by utilizing a zero-based index into a table of allowed RB values indicating an assigned number of RBs. In a further example, the configuration component 156 may map the RIV 154 to the constrained set 158 of one or more RBs by determining the RIV 154 according to:

RIV=Nmax*(L′)+S, for low values of L′

or

RIV=Nmax*(Nmax−(L′))+(Nmax−1−S), otherwise

where Nmax is a maximum number of RBs, L′ is a zero-based index into a table of values corresponding to the constrained set 158 of one or more RBs indicating an assigned number of RBs, and S is a value of a starting RB index number. Here low values of L′ could correspond to values that don't exceed a threshold, such as floor(Nmax/2).

Additionally, in another example, the configuration component 156 may map the RIV 154 to the constrained set 158 of one or more RBs by mapping the RIV 154 to a respective one of each possible pair of starting RB index number and number of RBs in the constrained set 158 of one or more RBs. This avoids assigning RIV values to pairs that are not allowed. For example, certain pairs may be disallowed because of constraints on the number of RBs assigned due to DFT-s-OFDM waveform, or due to further constraints on the start RB imposed by a restrictive scheduling mode. The scheduling mode may be restrictive so as to allow encoding the RIV using fewer number of bits.

In an aspect, the RB indexing component 150 and/or the configuration component 156 may check if the scheduling grant 152 is valid based on a number of the allocated RBs. The RB indexing component 150 and/or the configuration component 156 may check if the scheduling grant 152 is valid by either determining whether the number of the allocated RBs equals a number of allowed RBs, determining that the scheduling grant 152 is not valid based on a first determination that the number of the allocated RBs does not equal the number of allowed RBs, or determining that the scheduling grant 152 is valid based on a second determination that the number of allocated RBs equals the number of allowed RBs. In an example, the RB indexing component 150 and/or the configuration component 156 may check if the scheduling grant 152 is valid based on a number of the allocated RBs before mapping the RIV 154 to the constrained set 158 of one or more RBs. If the RB indexing component 150 and/or the configuration component 156 determines that the scheduling grant 152 is valid, then the RB indexing component 150 and/or the configuration component 156 may map the RIV 154 to the constrained set 158 of one or more RBs.

In an aspect, the RB indexing component 150 and/or the configuration component 156 may check if the scheduling grant 152 is valid at least in part based on a bit size of the scheduling grant 152 where the RIV 154 may correspond to a plurality of scheduling schemes each resulting in a different bit size of the scheduling grant 152. In another aspect, the RIV 154 may include a set bit size, and thus, the RB indexing component 150 and/or the configuration component 156 may check if the scheduling grant 152 is valid based at least in part on detecting a value of padding bits within the set bit size.

In an aspect, the UE 110 and/or the RB indexing component 150 may include a communication component 162 which may be configured to communicate, with the base station 105 via the communication channel 135, using the allocated RBs 164 from the constrained set 158 158 of one or more RBs as signaled by the RIV 154 154.

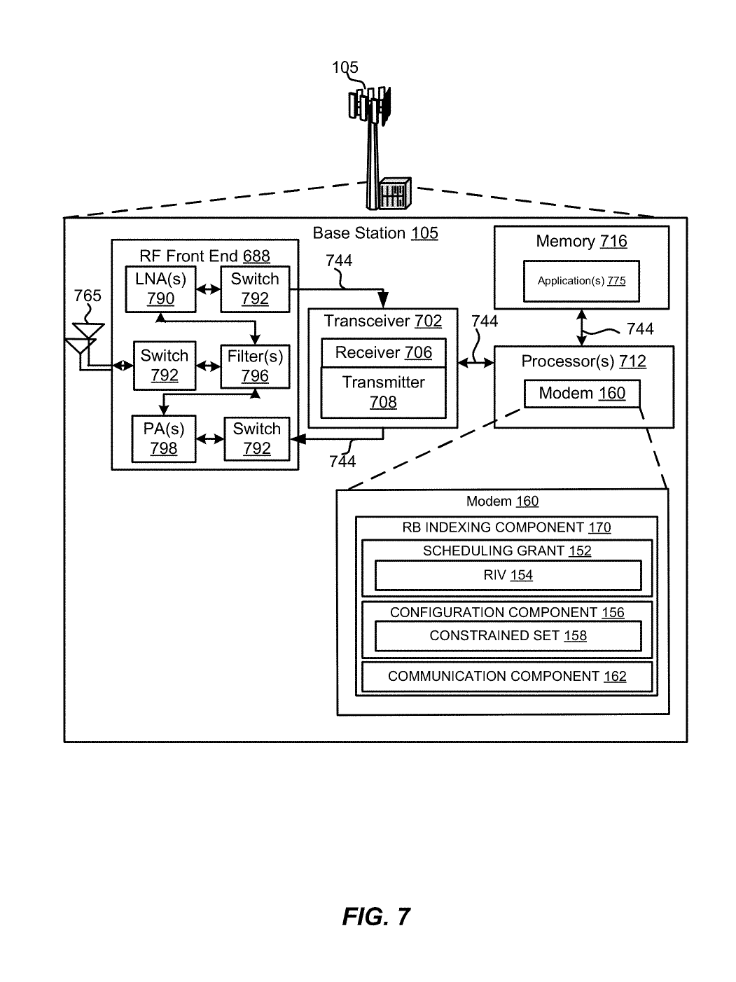

In an aspect, the scheduling grant 152 may correspond to an uplink scheduling grant 152. For example, the UE 110 and/or the RB indexing component 150 may execute a transceiver 702 (see, e.g., FIG. 7) to transmit, via the communication channel 135, data on each RB of the allocated RBs 164 from the constrained set 158 of one or more RBs to the transmitting wireless device. In this example, the UE 110 and/or the RB indexing component 150 may execute a transceiver 702 to transmit the data on each RB of the allocated RBs 164 from the constrained set 158 of one or more RBs using a multi-cluster allocation configuring the RIV 154 as a combinatorial index indicating a start RB Group (RBG) index and a stop RBG index for each cluster.

In an example, the UE 110 and/or the RB indexing component 150 may configure a RBG size and a bandwidth part (BWP). Further, the UE 110 and/or the RB indexing component 150 may execute a transceiver 702 (see, e.g., FIG. 7) to transmit the data on each RB of the allocated RBs 164 from the constrained set 158 of one or more RBs using the multi-cluster allocation based on the RBG size and the BWP.

In an aspect, the scheduling grant 152 may correspond to an downlink scheduling grant 152. For example, the UE 110 and/or the RB indexing component 150 may execute a transceiver 702 to receive, via the communication channel 135, data on each RB of the allocated RBs 164 from the constrained set 158 of one or more RBs from the transmitting wireless device.

The wireless communication network 100 may include one or more base stations 105, one or more UEs 110, and a core network 115. The core network 115 may provide user authentication, access authorization, tracking, interne protocol (IP) connectivity, and other access, routing, or mobility functions. The base stations 105 may interface with the core network 115 through backhaul links 120 (e.g., S1, etc.). The base stations 105 may perform radio configuration and scheduling for communication with the UEs 110, or may operate under the control of a base station controller (not shown). In various examples, the base stations 105 may communicate, either directly or indirectly (e.g., through core network 115), with one another over backhaul links 125 (e.g., X1, etc.), which may be wired or wireless communication links.

The core network 115 may correspond to 5G Core (5GC) which may include one or more Access and Mobility Management Function (AMF), a Session Management Function (SMF), and a User Plane Function (UPF). The AMF may be in communication with a Unified Data Management (UDM). The AMF is the control node that processes the signaling between the UEs 110 and the core network (e.g., 5GC). Generally, the AMF provides QoS flow and session management. All user Internet protocol (IP) packets are transferred through the UPF. The UPF provides UE IP address allocation as well as other functions. The UPF is connected to the IP Services. The IP Services may include the Internet, an intranet, an IP Multimedia Subsystem (IMS), a PS Streaming Service, and/or other IP services.

The base stations 105 may wirelessly communicate with the UEs 110 via one or more base station antennas. Each of the base stations 105 may provide communication coverage for a respective geographic coverage area 130. In some examples, the base stations 105 may be referred to as a base transceiver station, a radio base station, an access point, an access node, a radio transceiver, a NodeB, eNodeB (eNB), gNodeB (gNB), Home NodeB, a Home eNodeB, a relay, or some other suitable terminology. The geographic coverage area 130 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a new radio (NR) or 5G technology, a Long Term Evolution (LTE) or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by the UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by the UEs 110 with service subscriptions with the network provider. A femto cell may also cover a small geographic area (e.g., a home) and may provide restricted access and/or unrestricted access by the UEs 110 having an association with the femto cell (e.g., in the restricted access case, the UEs 110 in a closed subscriber group (CSG) of the base station 105, which may include the UEs 110 for users in the home, and the like). A micro cell may cover a geographic area larger than a pico cell and a femto cell, but smaller than a macro cell. An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base station 105. The RRC protocol layer may also be used for core network 115 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 110 may be able to communicate with various types of base stations 105 and network equipment including macro eNBs, small cell eNBs, macro gNBs, small cell gNBs, relay base stations, and the like.

Certain UEs 110 may communicate with each other using device-to-device (D2D) communication link 135. The D2D communication link 135 may use the DL/UL WWAN spectrum. The D2D communication link 135 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 110 may be configured with multiple downlink CCs and one or more uplink CCs for carrier aggregation. Carrier aggregation may be used with both FDD and TDD component carriers. The base stations 105 and UEs 110 may use spectrum up to Y MHz (e.g., Y=5, 10, 15, or 20 MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

Additionally, one or more of base stations 105 and/or UEs 110 may operate according to a NR or 5G technology referred to as millimeter wave (mmW or mmwave or MMW) technology. For example, mmW technology includes transmissions in mmW frequencies and/or near mmW frequencies. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. For example, the super high frequency (SHF) band extends between 3 GHz and 30 GHz, and may also be referred to as centimeter wave. Communications using the mmW and/or near mmW radio frequency band has extremely high path loss and a short range. As such, base stations 105 and/or UEs 110 operating according to the mmW technology may utilize beamforming in their transmissions to compensate for the extremely high path loss and short range.

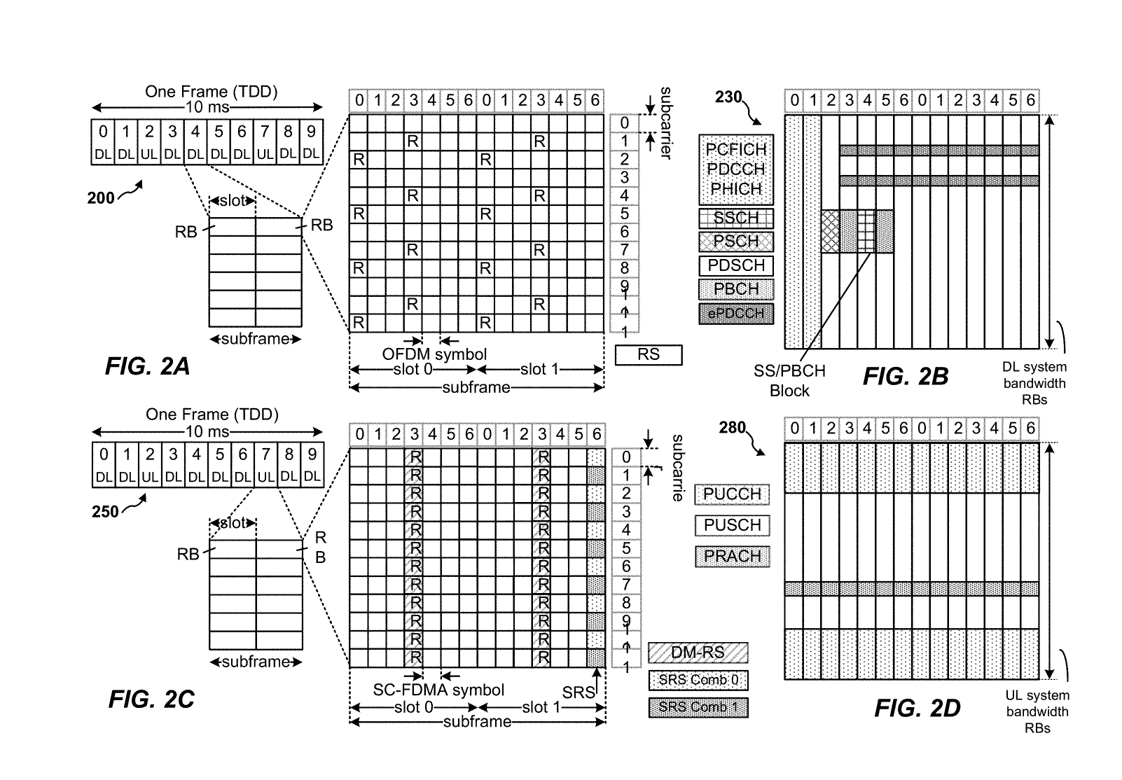

FIGS. 2A-2D provide example frame structures, one or more of which may include a contrained set of RBs into which an RIV may be mapped according to the scheduling schemes described herein. FIG. 2A is a diagram 200 illustrating an example of a DL subframe within a 5G/NR frame structure. FIG. 2B is a diagram 230 illustrating an example of channels within a DL subframe. FIG. 2C is a diagram 250 illustrating an example of an UL subframe within a 5G/NR frame structure. FIG. 2D is a diagram 280 illustrating an example of channels within an UL subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 a DL subframe and subframe 7 an UL subframe. While subframe 4 is illustrated as providing just DL and subframe 7 is illustrated as providing just UL, any particular subframe may be split into different subsets that provide both UL and DL. Note that the description infra applies also to a 5G/NR frame structure that is FDD.

Other wireless communication technologies may have a different frame structure and/or different channels. A frame (10 ms) may be divided into 10 equally sized subframes (1 ms). Each subframe may include one or more time slots. Each slot may include 7 or 14 symbols, depending on the slot configuration. For slot configuration 0, each slot may include 14 symbols, and for slot configuration 1, each slot may include 7 symbols. The number of slots within a subframe is based on the slot configuration and the numerology. For slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. The subcarrier spacing and symbol length/duration are a function of the numerology. The subcarrier spacing may be equal to 2^{μ}*15 kKz, where μ is the numerology 0-5. The symbol length/duration is inversely related to the subcarrier spacing. FIGS. 2A, 2C provide an example of slot configuration 1 with 7 symbols per slot and numerology 0 with 2 slots per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE (indicated as R). The RS may include demodulation RS (DM-RS) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 110 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS)/PBCH block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

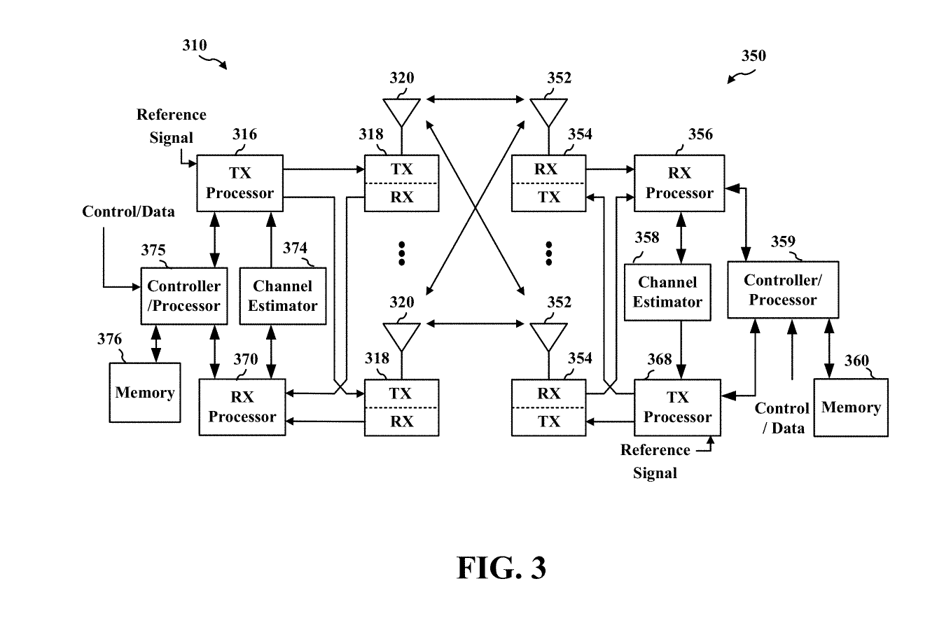

FIG. 3 is a block diagram of a base station 310 in communication with a UE 350 in an access network. In the DL, IP packets from the EPC may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

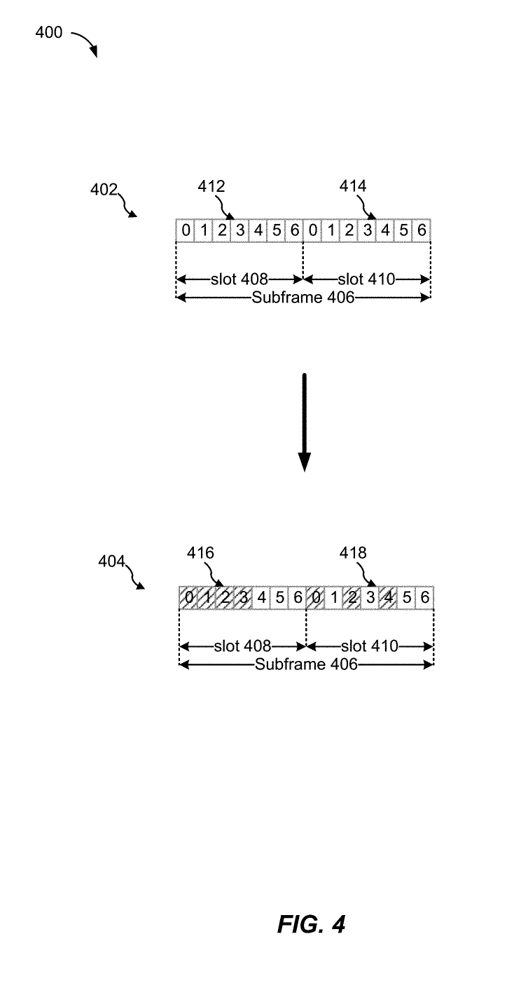

FIG. 4 is a conceptual diagram of an example of a scenario 400 for RB indexing in accordance with one or more aspects. For example, the RB indexing component 150 and/or 170 may be configured to allocate resources for a subframe 406 with slots 408 and 410. In an aspect, for configuration 402, subframe 406 may include a number of available RBs 412 and 414 in slots 408 and 410, respectively. The RB indexing component 150 and/or 170 may map a RIV 154 to a constrained set of one or more RBs to identify allocated RBs 416 and 418. In this example, referring to configuration 404, subframe 406 may include a constrained set of contiguously allocated RBs 416 for slot 408 corresponding to RBs 0, 1, 2, and 4. Further, for slot 408, the a constrained set of RBs may include non-contiguously allocated RBs 418 for slot 410 corresponding to RBs 0, 2, and 4. As such, according to the present aspects, the receiving wireless device can map the RIV 154 into the constained set of RBs as opposed to mapping the RIV 154 into all RBs within each slot.

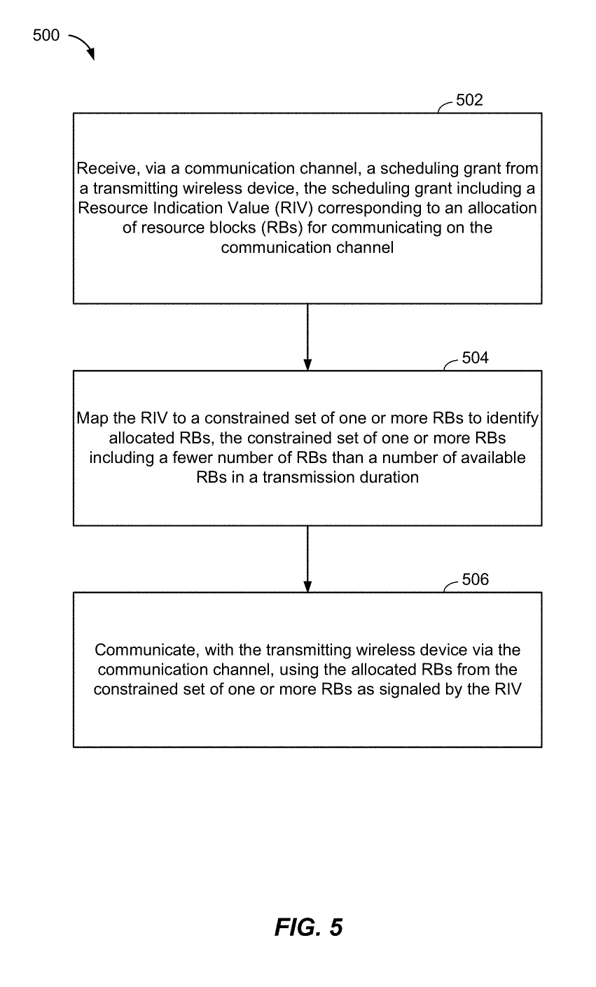

FIG. 5 is a flow diagram illustrating examples of a method 500 related to RB indexing in accordance with various aspects of the present disclosure. Although the operations described below are presented in a particular order and/or as being performed by an example component, it should be understood that the ordering of the actions and the components performing the actions may be varied, depending on the implementation. Also, although the RB indexing component 150 is illustrated as having a number of subcomponents, it should be understood that one or more of the illustrated subcomponents may be separate from, but in communication with, the RB indexing component 150, and/or each other. Moreover, it should be understood that any of actions or components described below with respect to the RB indexing component 150 and/or its subcomponents may be performed by a specially-programmed processor, a processor executing specially-programmed software or computer-readable media, or by any other combination of a hardware component and/or a software component specially configured for performing the described actions or components. Additionally, while the below method may be explained with reference to the UE 110 being the receiving wireless device operating RB indexing component 150, it should be understood that in other implementations base station or gNB 105 may be the receiving wireless device and may operate RB indexing component 170 in a similar manner as UE 110 operates RB indexing component 150. Moreover, RB indexing component 150 and/or 170, and their corresponding subcomponents, may be implemented by and/or executed on a processor and/or modem of the respective UE 110 and/or base station 105.

In an aspect, at block 502, the method 500 may receive, via a communication channel, a scheduling grant from a transmitting wireless device, the scheduling grant including a RIV corresponding to an allocation of RBs for communicating on the communication channel. In an aspect, for example, the UE 110 and/or RB indexing component 150 may receive, via a communication channel 135 and via an antenna, RF front end, transceiver, processor and/or modem, a scheduling grant 152 from a base station 105, the scheduling grant 152 including a RIV 154 corresponding to an allocation of RBs for communicating on the communication channel 135.

In an aspect, at block 504, the method 500 may map the RIV to a constrained set of one or more RBs to identify allocated RBs, the constrained set of one or more RBs including a fewer number of RBs than a number of available RBs in a slot or transmission duration. In an aspect, for example, the UE 110 and/or RB indexing component 150 may execute configuration component 156 to map the RIV 154 to a constrained set 158 of one or more RBs to identify allocated RBs 164, the constrained set 158 of one or more RBs including a fewer number of RBs than a number of available RBs in a slot or transmission duration.

In an aspect, at block 506, the method 500 may communicate, with the transmitting wireless device via the communication channel, using the allocated RBs from the constrained set of one or more RBs as signaled by the RIV. In an aspect, for example, the UE 110 and/or RB indexing component 150 may execute communication component 162 to communicate, with the base station 105 via the communication channel 135, using the allocated RBs 164 from the constrained set 158 of one or more RBs as signaled by the RIV 154.

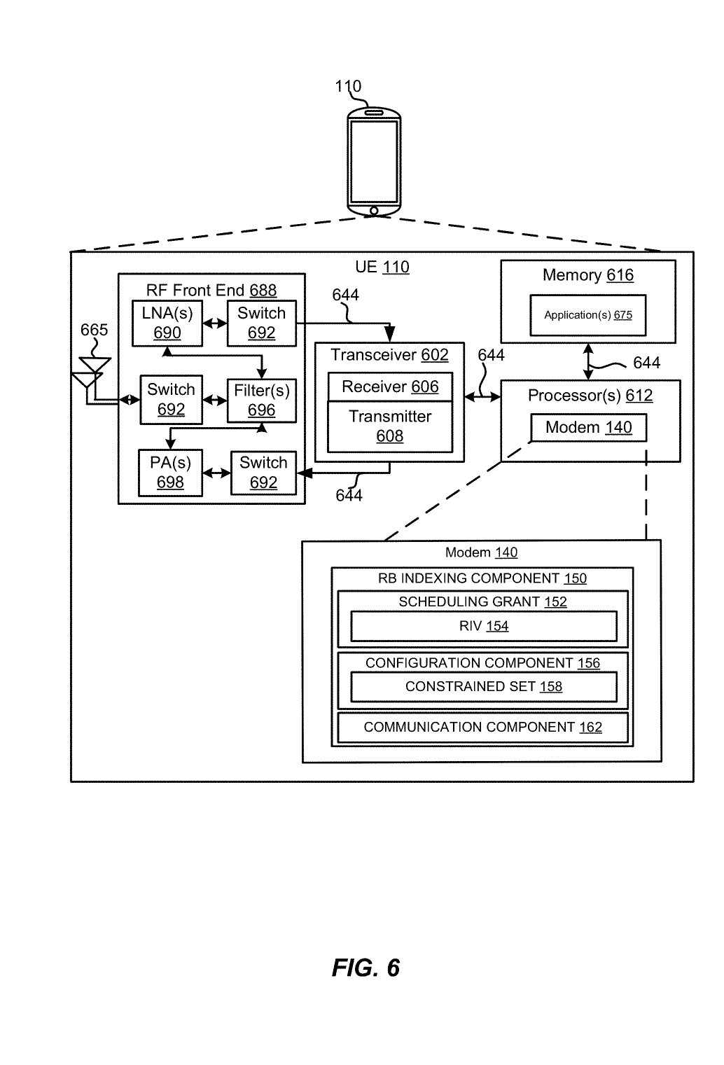

Referring to FIG. 6, one example of an implementation of an UE 110 may include a variety of components, some of which have already been described above, but including components such as one or more processors 612 and memory 616 and transceiver 602 in communication via one or more buses 644, which may operate in conjunction with modem 140 and RB indexing component 150 to enable one or more of the functions described herein related to RB indexing in a wireless communication system. Further, the one or more processors 612, modem 614, memory 616, transceiver 602, radio frequency (RF) front end 688 and one or more antennas 665, may be configured to support voice and/or data calls (simultaneously or non-simultaneously) in one or more radio access technologies. In some aspects, the modem 140 may be the same as or similar to the modem 140 (FIG. 1).

In an aspect, the one or more processors 612 can include a modem 140 that uses one or more modem processors. The various functions related to RB indexing component 150 may be included in modem 140 and/or processors 612 and, in an aspect, can be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with the transceiver 602. In other aspects, some of the features of the one or more processors 612 and/or modem 140 associated with RB indexing component 150 may be performed by transceiver 602.

Also, memory 616 may be configured to store data used herein and/or local versions of applications 675 or RB indexing component 150 and/or one or more of its subcomponents being executed by at least one processor 612. Memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining RB indexing component 150 and/or one or more of its subcomponents, and/or data associated therewith, when UE 110 is operating at least one processor 612 to execute RB indexing component 150 and/or one or more of its subcomponents.

The transceiver 602 may include at least one receiver 606 and at least one transmitter 608. The receiver 606 may include hardware, firmware, and/or software code executable by a processor for receiving data, the code comprising instructions and being stored in a memory (e.g., computer-readable medium). The receiver 606 may be, for example, a RF receiver. In an aspect, the receiver 606 may receive signals transmitted by at least one base station 105. Additionally, the receiver 606 may process such received signals, and also may obtain measurements of the signals, such as, but not limited to, Ec/Io, SNR, RSRP, RSSI, etc. The transmitter 608 may include hardware, firmware, and/or software code executable by a processor for transmitting data, the code comprising instructions and being stored in a memory (e.g., computer-readable medium). A suitable example of the transmitter 608 may include, but is not limited to, an RF transmitter.

Moreover, in an aspect, the UE 110 may include an RF front end 688, which may operate in communication with one or more antennas 665 and transceiver 602 for receiving and transmitting radio transmissions, for example, wireless communications transmitted by at least one base station 105, wireless transmissions received from neighbor UEs 206 and/or 208, or wireless transmissions transmitted by the UE 110. The RF front end 688 may be connected to one or more antennas 665 and can include one or more low-noise amplifiers (LNAs) 690, one or more switches 692, one or more power amplifiers (PAs) 698, and one or more filters 696 for transmitting and receiving RF signals.

In an aspect, the LNA 690 can amplify a received signal at a desired output level. In an aspect, each LNA 690 may have a specified minimum and maximum gain values. In an aspect, RF front end 688 may use one or more switches 692 to select a particular LNA 690 and its specified gain value based on a desired gain value for a particular application.

Further, for example, one or more PA(s) 698 may be used by the RF front end 688 to amplify a signal for an RF output at a desired output power level. In an aspect, each PA 698 may have specified minimum and maximum gain values. In an aspect, the RF front end 688 may use one or more switches 692 to select a particular PA 698 and a corresponding specified gain value based on a desired gain value for a particular application.

Also, for example, one or more filters 696 can be used by the RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, the RF front end 688 can use one or more switches 692 to select a transmit or receive path using a specified filter 696, LNA 690, and/or PA 698, based on a configuration as specified by transceiver 602 and/or processor 612.

As such, the transceiver 602 may be configured to transmit and receive wireless signals through one or more antennas 665 via RF front end 688. In an aspect, the transceiver 602 may be tuned to operate at specified frequencies such that the UE 110 can communicate with, for example, one or more base stations 105 or one or more cells associated with one or more base stations 105. In an aspect, for example, the modem 140 can configure the transceiver 602 to operate at a specified frequency and power level based on the UE configuration of the UE 110 and the communication protocol used by the modem 140.

In an aspect, modem 140 can be a multiband-multimode modem, which can process digital data and communicate with the transceiver 602 such that the digital data is sent and received using the transceiver 602. In an aspect, the modem 140 can be multiband and be configured to support multiple frequency bands for a specific communications protocol. In an aspect, the modem 140 can be multimode and be configured to support multiple operating networks and communications protocols. In an aspect, the modem 140 can control one or more components of the UE 110 (e.g., RF front end 688, transceiver 602) to enable transmission and/or reception of signals from the network based on a specified modem configuration. In an aspect, the modem configuration can be based on the mode of the modem and the frequency band in use. In another aspect, the modem configuration can be based on UE configuration information associated with the UE 110 as provided by the network during cell selection and/or cell reselection.

Referring to FIG. 7, one example of an implementation of base station 105 may include a variety of components, some of which have already been described above, but including components such as one or more processors 712, a memory 716, and a transceiver 702 in communication via one or more buses 744, which may operate in conjunction with modem 160 and the RB indexing component 170.

The transceiver 702, receiver 706, transmitter 708, one or more processors 712, memory 716, applications 775, buses 744, RF front end 788, LNAs 790, switches 792, filters 796, PAs 798, and one or more antennas 765 may be the same as or similar to the corresponding components of UE 110, as described above, but configured or otherwise programmed for base station operations as opposed to UE operations.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of wireless communication, comprising:
receiving, via a communication channel, a scheduling grant from a transmitting wireless device, the scheduling grant including a Resource Indication Value (RIV) corresponding to an allocation of resource blocks (RBs) for communicating on the communication channel;
mapping the RIV to a constrained set of one or more RBs to identify allocated RBs, the constrained set of one or more RBs including a fewer number of RBs than a number of available RBs in a transmission duration; and
communicating, with the transmitting wireless device via the communication channel, using the allocated RBs from the constrained set of one or more RBs as signaled by the RIV.

2. The method of claim 1, further comprising:
receiving, via the communication channel, a scheduling scheme indicator associated with the scheduling grant, the scheduling scheme indicator identifying a scheduling scheme related to the scheduling grant;
determining the scheduling scheme based at least on a value of the scheduling scheme indicator; and
wherein mapping the RIV to the constrained set of one or more RBs further comprises mapping based at least on the scheduling scheme.

3. The method of claim 2, wherein the scheduling scheme comprises a waveform-based scheme or a resource-allocation type scheme.

4. The method of claim 2, wherein the scheduling scheme corresponds to Discrete Fourier Transform Spreading Orthogonal Frequency Division Multiplexing (DFTS-OFDM).

5. The method of claim 4, wherein mapping the RIV to the constrained set of one or more RBs further comprises utilizing an index into a table of allowed RB values indicating an assigned number of RBs.

6. The method of claim 4, wherein mapping the RIV to the constrained set of one or more RBs further comprises determining the RIV according to;
RIV=Nmax*(L′)+S, if L′≤T
or
RIV=Nmax*(Nmax−(L′))+(Nmax−1−S), if L′>T
where:
Nmax is a maximum number of RBs;
L′ is a zero-based index into a table of values corresponding to the constrained set of one or more RBs indicating an assigned number of RBs;
S is a value of a starting RB index number; and
T is a threshold, e.g., T=floor(Nmax/2).

7. The method of claim 4, wherein mapping the RIV to the constrained set of one or more RBs further comprises mapping the RIV to a respective one of each possible pair of starting RB index number and number of RBs in the constrained set of one or more RBs.

8. The method of claim 1, further comprising checking if the scheduling grant is valid based on a number of the allocated RBs.

9. The method of claim 8, wherein checking if the scheduling grant is valid further comprises:
determining whether the number of the allocated RBs equals a number of allowed RBs;
determining that the scheduling grant is not valid based on a first determination that the number of the allocated RBs does not equal the number of allowed RBs; or
determining that the scheduling grant is valid based on a second determination that the number of allocated RBs equals the number of allowed RBs.

10. The method of claim 1, further comprising checking if the scheduling grant is valid at least in part based on a bit size of the scheduling grant where the RIV may correspond to a plurality of scheduling schemes each resulting in a different bit size of the scheduling grant.

11. The method of claim 1, wherein the RIV includes a set bit size, further comprising checking if the scheduling grant is valid based at least in part on detecting a value of padding bits within the set bit size.

12. The method of claim 1, wherein the scheduling grant corresponds to an uplink scheduling grant; and
wherein communicating using the allocated RBs from the constrained set of one or more RBs as signaled by the RIV further comprises transmitting, via the communication channel, data on each RB of the allocated RBs from the constrained set of one or more RBs to the transmitting wireless device.

13. The method of claim 12, wherein transmitting the data on each RB of the allocated RBs from the constrained set of one or more RBs further comprises transmitting the data on each RB of the allocated RBs from the constrained set of one or more RBs using a multi-cluster allocation configuring the RIV as a combinatorial index indicating a start RB Group (RBG) index and a stop RBG index for each cluster.

14. The method of claim 13, further comprising:
configuring a RBG size and a bandwidth part (BWP); and
wherein transmitting the data on each RB of the allocated RBs from the constrained set of one or more RBs using the multi-cluster allocation further comprises transmitting the data on each RB of the allocated RBs from the constrained set of one or more RBs using the multi-cluster allocation based on the RBG size and the BWP.

15. The method of claim 1, wherein the scheduling grant corresponds to a downlink scheduling grant; and
wherein communicating using the allocated RBs from the constrained set of one or more RBs further comprises receiving, via the communication channel, data on each RB of the allocated RBs from the constrained set of one or more RBs from the transmitting wireless device.

16. An apparatus for wireless communications, comprising:
a memory; and
a processor coupled with the memory and configured to:
receive, via a communication channel, a scheduling grant from a transmitting wireless device, the scheduling grant including a Resource Indication Value (RIV) corresponding to an allocation of resource blocks (RBs) for communicating on the communication channel;
map the RIV to a constrained set of one or more RBs to identify allocated RBs, the constrained set of one or more RBs including a fewer number of RBs than a number of available RBs in a slot; and
communicate, with the transmitting wireless device via the communication channel, using the allocated RBs from the constrained set of one or more RBs as signaled by the RIV.

17. The apparatus of claim 16, wherein the processor is configured to:
receive, via the communication channel, a scheduling scheme indicator associated with the scheduling grant, the scheduling scheme indicator identifying a scheduling scheme related to the scheduling grant;
determine the scheduling scheme based at least on a value of the scheduling scheme indicator; and
wherein the processor configured to map the RIV to the constrained set of one or more RBs further maps based at least on the scheduling scheme.

18. The apparatus of claim 17, wherein the scheduling scheme comprises a waveform-based scheme or a resource-allocation type scheme.

19. The apparatus of claim 17, wherein the scheduling scheme corresponds to Discrete Fourier Transform Spreading Orthogonal Frequency Division Multiplexing (DFTS-OFDM).

20. The apparatus of claim 19, wherein mapping the RIV to the constrained set of one or more RBs further comprises utilizing an index into a table of allowed RB values indicating an assigned number of RBs.

21. The apparatus of claim 19, wherein mapping the RIV to the constrained set of one or more RBs further comprises determining the RIV according to;
RIV=Nmax*(L′)+S, if L′<T
or
RIV=Nmax*(Nmax−(L′))+(Nmax−1−S), if L′>T
where:
Nmax is a maximum number of RBs;
L′ is a zero-based index into a table of values corresponding to the constrained set of one or more RBs indicating an assigned number of RBs;
S is a value of a starting RB index number; and
T is a threshold, e.g., T=floor(Nmax/2).

22. The apparatus of claim 19, wherein mapping the RIV to the constrained set of one or more RBs further comprises mapping the RIV to a respective one of each possible pair of starting RB index number and number of RBs in the constrained set of one or more RBs.

23. The apparatus of claim 16, wherein the processor is further configured to check if the scheduling grant is valid based on a number of the allocated RBs, wherein checking if the scheduling grant is valid further comprises:
determining whether the number of the allocated RBs equals a number of allowed RBs;
determining that the scheduling grant is not valid based on a first determination that the number of the allocated RBs does not equal the number of allowed RBs; or
determining that the scheduling grant is valid based on a second determination that the number of allocated RBs equals the number of allowed RBs.

24. The apparatus of claim 16, further comprising checking if the scheduling grant is valid at least in part based on a bit size of the scheduling grant where the RIV may correspond to a plurality of scheduling schemes each resulting in a different bit size of the scheduling grant.

25. The apparatus of claim 16, wherein the RIV includes a set bit size, further comprising checking if the scheduling grant is valid based at least in part on detecting a value of padding bits within the set bit size.

26. The apparatus of claim 16, wherein the scheduling grant corresponds to an uplink scheduling grant; and
wherein communicating using the allocated RBs from the constrained set of one or more RBs as signaled by the RIV further comprises transmitting, via the communication channel, data on each RB of the allocated RBs from the constrained set of one or more RBs to the transmitting wireless device.

27. The apparatus of claim 16, wherein the processor is configured to:
configure a RBG size and a bandwidth part (BWP); and
wherein the processor configured to transmit the data on each RB of the allocated RBs from the constrained set of one or more RBs further transmits the data on each RB of the allocated RBs from the constrained set of one or more RBs using a multi-cluster allocation configuring the RIV as a combinatorial index indicating a start RB Group (RBG) index and a stop RBG index for each cluster based on the RBG size and the BWP.

28. The apparatus of claim 16, wherein the scheduling grant corresponds to a downlink scheduling grant; and
wherein communicating using the allocated RBs from the constrained set of one or more RBs further comprises receiving, via the communication channel, data on each RB of the allocated RBs from the constrained set of one or more RBs from the transmitting wireless device.

29. An apparatus for wireless communications, comprising:
means for receiving, via a communication channel, a scheduling grant from a transmitting wireless device, the scheduling grant including a Resource Indication Value (RIV) corresponding to an allocation of resource blocks (RBs) for communicating on the communication channel;
means for mapping the RIV to a constrained set of one or more RBs to identify allocated RBs, the constrained set of one or more RBs including a fewer number of RBs than a number of available RBs in a transmission duration; and
means for communicating, with the transmitting wireless device via the communication channel, using the allocated RBs from the constrained set of one or more RBs as signaled by the RIV.

30. A computer-readable medium storing computer executable code for wireless communications, comprising code for:
receiving, via a communication channel, a scheduling grant from a transmitting wireless device, the scheduling grant including a Resource Indication Value (RIV) corresponding to an allocation of resource blocks (RBs) for communicating on the communication channel;
mapping the RIV to a constrained set of one or more RBs to identify allocated RBs, the constrained set of one or more RBs including a fewer number of RBs than a number of available RBs in a transmission duration; and
communicating, with the transmitting wireless device via the communication channel, using the allocated RBs from the constrained set of one or more RBs as signaled by the RIV.
